(19) United States
(12) Patent Application Publication
(10) Pub. No.: US 2025/0051071 A1
(43) Pub. Date: Feb. 13, 2025

(54) SMART CONNECTED DIGITAL CONTAINER BOLT SEAL AND ASSOCIATED METHODS

(71) Applicants: AT&T Global Network Services Belgium Luxembourg SPRL, Vilvoorde (BE); AT&T Global Network Services Danmark APS, Holte (DK)

(72) Inventors: Tom Van Deynze, Boechout (BE); Kim Velgaard, Slagelse (DK)

(73) Assignees: AT&T Global Network Services Belgium Luxembourg SPRL, Vilvoorde (BE); AT&T Global Network Services Danmark APS, Holte (DK)

(21) Appl. No.: 18/446,867

(22) Filed: Aug. 9, 2023

(51) Int. Cl. B65D 55/02

(52) U.S. Cl. CPC B65D 55/028; B65D 2203/06; B65D 2203/10; B65D 2401/00

(57) ABSTRACT

Aspects of the subject disclosure may include, for example, a container bolt seal, comprising: a rod portion having first and second ends; a head located at the first end of the rod portion, wherein at least one outer cross-sectional dimension of the head is greater than a largest outer cross-sectional dimension of the rod portion; a locking member, wherein at least one outer cross-sectional dimension of the locking member is greater than the largest outer cross-sectional dimension of the rod portion, wherein the locking member is configured for placement on the second end of the rod portion, and wherein the locking member becomes non-removably attached to the rod portion after placement on the second end of the rod portion; and an electronic processor that facilitates wireless communications comprising a first message indicative of a time and location of a bolt-sealing event and a second message indicative of a time and location of a status event. Other embodiments are disclosed.

### FIELD OF THE DISCLOSURE

The subject disclosure relates to a smart connected digital container bolt seal and associated methods.

### BACKGROUND

In December 2022, the global market volume of container shipments was 140.7 million Twenty-Foot Equivalent Units (TEU) per year, expected to grow +3.3% CAGR according to DGF Global Forwarding. The vast majority of these containers are sealed for shipment and movement is currently tracked by Equipment Interchange Receipt documents issued by the container owner (shipping line), signed by the relevant parties.

Bad actors often intercept containers (at any stage during the container journey), and tamper with the seal to: (a) obtain unauthorized access to the cargo; and/or (b) add unauthorized cargo to the container. The container user, shipping line, and/or customs authority are not always able to observe this tampering activity (or observe it only towards the end of the journey). The unauthorized access by the bad actors often leads to financial and reputational damage for the container user and/or the container owner.

Certain conventional mechanisms that are being used comprise electronic container locks requiring a smartphone or application to lock and unlock (such mechanisms are typically packaged in a rather bulky enclosure) and can easily be damaged during the normal handling of a shipping container. These mechanisms also typically require a specific and additional process for installation, as one still requires ISO17712 certified container seals required by the leading shipping lines and customs authorities.

Another conventional mechanism comprises a permanently installed container tracking system that can be extended with a “door sensor” that captures opening of the container door.

### BRIEF DESCRIPTION OF THE DRAWINGS

Reference will now be made to the accompanying drawings, which are not necessarily drawn to scale, and wherein:

FIG. 1A is a diagram illustrating a front view of an example, non-limiting embodiment of a container bolt seal in accordance with various aspects described herein.

FIG. 1B is a diagram illustrating a side view of the container bolt seal shown in FIG. 1A.

FIG. 1C is a block diagram illustrating an example, non-limiting embodiment of a system in accordance with various aspects described herein.

FIG. 2A is a diagram illustrating a partially cut-away view of an example, non-limiting embodiment of a container bolt seal in accordance with various aspects described herein.

FIG. 2B is a diagram illustrating a front view of an example, non-limiting embodiment of a portion of a container bolt seal (without locking member) in accordance with various aspects described herein.

FIG. 2C is a diagram illustrating a top view of the portion of the container bolt seal shown in FIG. 2B.

FIG. 2D is a diagram illustrating a front view of an example, non-limiting embodiment of a container bolt seal locking member in accordance with various aspects described herein.

FIG. 2E is a diagram illustrating a top view of the container bolt seal locking member shown in FIG. 2D.

FIG. 2F is a diagram illustrating a front view of an example, non-limiting embodiment of a container bolt seal in accordance with various aspects described herein.

FIG. 2G is a diagram illustrating an example, non-limiting embodiment of a container bolt seal (as installed on an example shipping container) in accordance with various aspects described herein.

FIG. 3 depicts an illustrative embodiment of a method in accordance with various aspects described herein.

FIG. 4 is a block diagram of an example, non-limiting embodiment of a computing environment in accordance with various aspects described herein.

FIG. 5 is a block diagram of an example, non-limiting embodiment of a communication device in accordance with various aspects described herein.

### DETAILED DESCRIPTION

The subject disclosure describes, among other things, illustrative embodiments for a smart connected digital container bolt seal and associated methods. Other embodiments are described in the subject disclosure.

One or more aspects of the subject disclosure include mechanisms to inform a user (and/or owner) of an intermodal shipping container or truck trailer (that can be locked with a container door latch) as to when and where the door is sealed and when and where the seal is eventually cut.

One or more aspects of the subject disclosure include mechanisms for detecting and reporting closure and cut of the digital container bolt seal, as well as mechanisms for reporting the digital container bolt seal's status and location on regular and/or programmable intervals or moments in time (e.g., date/time).

One or more aspects of the subject disclosure relate to an ISO/PAS 17712 “high” compliant bolt seal that is “digitized” so that its status (e.g., first closed, subsequently closed, cut) can be telecommunicated.

One or more aspects of the subject disclosure include mechanisms that provide innovative packaging of a battery (and/or other energy distribution mechanism), a microcontroller, one or more sensors, and a Wide Area Network Wireless module in the physical form factor of an IS017712 H bolt seal. Using this bolt seal form factor means (according to various embodiments) that there is no (or essentially no) additional installation process required to allow the owner and/or user of the container to know if the seal has been closed or cut at a non-expected location (after which the owner and/or user can then take the necessary steps to identify potential malicious activity and ensure safety and security of the cargo). Such a bolt seal according to various embodiments can securely report “closed”, “cut,” and intermediate “status” events with date/time and location to a back-end application.

One or more aspects of the subject disclosure include a container bolt seal, comprising: a rod portion having a first end and a second end; a head located at the first end of the rod portion, wherein at least one outer cross-sectional dimension of the head is greater than a largest outer cross-sectional dimension of the rod portion; a locking member (sometimes referred to as a “barrel”), wherein at least one outer cross-sectional dimension of the locking member is greater than the largest outer cross-sectional dimension of the rod portion, wherein the locking member is configured for placement on the second end of the rod portion, and wherein the locking member becomes non-removably attached to the rod portion after placement on the second end of the rod portion; and an electronic processor, wherein the electronic processor facilitates wireless communications, wherein the wireless communications comprise a first message indicative of a first time and a first location of a bolt-sealing event and at least one second message indicative of a second time and a second location of a status event, wherein the bolt-sealing event is when the locking member becomes non-removably attached to the rod portion after placement on the second end of the rod portion, and wherein the status event is subsequent to the bolt-sealing event.

One or more aspects of the subject disclosure include an apparatus, comprising: a rod having an integrated head disposed at a first end of the rod, wherein the rod has a first outside cross-section dimension, and wherein a second outside cross-section dimension of the head is greater than the first outside cross-section dimension of the rod; a cap element (sometimes referred to as a “barrel”), wherein a third outside cross-section dimension of the cap element is greater than the first outside cross-section dimension of the rod, wherein the rod has a second end opposite to the first end, and wherein the cap element becomes permanently attached to the rod after placement on the second end; an energy distribution element; an antenna; and a processing system configured to be powered by the energy distribution element, wherein the processing system facilitates wireless communications via the antenna, wherein the wireless communications comprise a first message indicative of a first time and a first location of a locking event and a second message indicative of a second time and a second location of a removal event, wherein the locking event is when the cap element becomes permanently attached to the rod after placement on the second end of the rod, wherein the removal event is subsequent to the locking event, and wherein the removal event is when either of the head or the cap element are destructively separated from the rod.

One or more aspects of the subject disclosure include a method, comprising: receiving, by a processing system including a processor, a first data feed from a first container bolt seal, wherein the first container bolt seal comprises a first rod portion having a first end and a second end, wherein the first container bolt seal further comprises a first head located at the first end of the first rod portion, wherein the first container bolt seal further comprises a first locking member (sometimes referred to as a “barrel”), wherein the first rod portion is sized such that at least a part of the first rod portion can fit through a standard-sized hole in a door locking handle retainer of a shipping container or a standard-sized hole in a “secure cam” position of a shipping container, wherein the first head is sized such that the first head cannot fit through the standard-sized hole in the door locking handle retainer of the shipping container or the standard-sized hole in the “secure cam” position of the shipping container, wherein the first container bolt seal is installed by passing the second end of the first rod portion through the standard-sized hole and then attaching the first locking member to the second end of the first rod portion, wherein the first container bolt seal further comprises a first electronic processor, wherein the first electronic processor facilitates wireless transmission of the first data feed, wherein the first data feed comprises an attachment message indicative of a first time and a first location of the first locking member being attached to the second end of the first rod portion, and wherein the first data feed further comprises a removal message indicative of a second time and a second location of either the first head or the first locking member being separated from the first rod portion; and displaying by the processing system, on a graphical user interface (GUI), geospatial information from the first data feed, wherein the displaying comprises displaying on a map the first location and displaying on the map the second location.

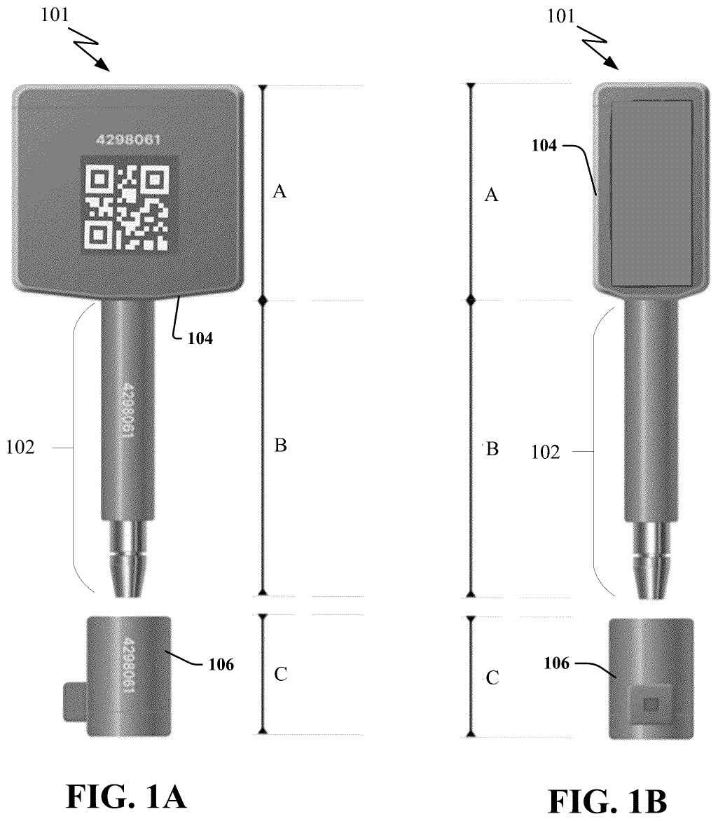

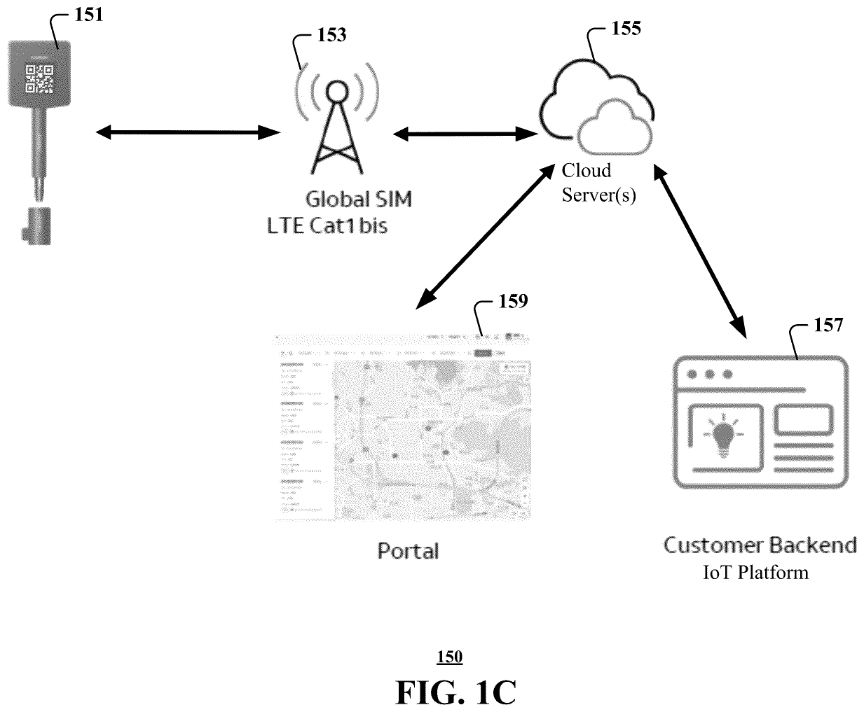

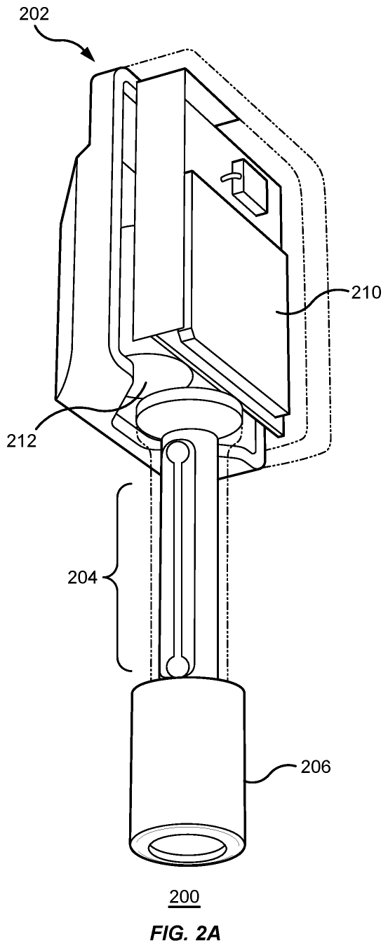

Referring now to FIGS. 1A and 1B, these are diagrams illustrating a front view (FIG. 1A) and a side view (FIG. 1B) of an example, non-limiting embodiment of a container bolt seal 101 in accordance with various aspects described herein. As seen in these figures, the container bolt seal 101 comprises a rod portion 102, a head 104 and a locking member (sometimes referred to as a “barrel”) 106. In one example, the head 104 is integral with the rod portion 102. In one example, the head 104 is formed so that it is not removable from the rod portion 102 without application of destructive force.

Still referring to FIGS. 1A and 1B, the locking member 106 is configured to be attachable to the rod portion 102 (at an end of the rod portion opposite the head). In one example, the rod portion 102 has a tapered end that is received into a matching female receptacle in the locking member 106. In one example, a spring-loaded retainer clip or the like (not shown) can be disposed within the female receptable of the locking member 106 in order to keep the locking member 106 on the shaft portion 102 after the locking member 106 has been attached thereto (the clip can interface with the groove in the end of the shaft portion). In one example, the locking member 106 is formed so that it is not removable from the rod portion 102 (after being attached thereto) without application of destructive force.

Still referring to FIGS. 1A and 1B, the container bolt seal 101 can include (not shown) a processor (e.g., a microprocessor), an antenna, an energy storage/distribution element (e.g., a battery), and one or more sensors. The processor can utilize the sensor(s) to detect one or more events as described herein (e.g., a bolt-scaling event when the locking member 106 is attached to the rod portion 102, a bolt-cutting event when the rod portion is cut (or the head 102 is otherwise removed, or the locking member 106 is otherwise removed). Further, the processor can utilize the antenna to transmit one or more messages indicating: the occurrence (time and location) of a bolt-sealing event, the occurrence (time and location) of a status event, and/or the occurrence (time and location of a bolt-cutting event. Further, the processor can utilize the antenna to receive one or more instructions, commands, updates, or the like. In one example, the processor, the antenna, the energy storage/distribution element, and the one or more sensors (or parts of such sensors) are located in the head 104.

Still referring to FIGS. 1A and 1B, the container bolt seal 101 can be utilized by placing the tapered end of the shaft portion 102 (without the locking member 106 being attached) through a standard-sized hole in a latch mechanism of a shipping container, and then attaching the locking member 106 to the shaft portion 102. The container bolt seal 101 will then be captive in the standard-sized hole (the head 104 is sized such that it is too large (in at least one dimension) to fit through the standard-sized hole in the latch mechanism and the locking member 106 is sized such that it is too large (in at least one dimension) to fit through the standard-sized hole in the latch mechanism). In one specific example, the length dimensions (see “A”, “B”, “C” in FIGS. 1A and 1B) of the container bolt seal 101 can be as follows: “A”=54 mm; “B”=74 mm; “C”=35 mm. In various examples, the container bolt seal 101 can provide for: (a) MQTT (Message Queuing Telemetry Transport) over LTE Cat 1 bis (global band support); (b) Shelf life of up to 24 months; (c) Journey time>6 months (without periodic status reporting); and/or (d) Journey time>6 weeks (with daily status reporting). In various examples, the container bolt seal 101 can have industry and regulatory compliance for: (a) FCC; (b) CE; (c) ISO 17712; (d) ATEX/Gas II 2 G Ex ib IIB T4 Gb −30° C.≤Ta≤60° C.; (c) ATEX/Dust II 2 D Ex ib IIIB T135° C. Db −30° C.≤Ta≤60° C.; and/or (f) IP66.

Referring now to FIG. 1C, this is a block diagram illustrating an example, non-limiting embodiment of system 150 in accordance with various aspects described herein. As seen in this figure, container bolt seal 151 (which can be constructed similarly to and operate in a manner similarly with container bolt seal 101 of FIGS. 1A and 1B) is configured for bi-directional wireless communications with wireless network 153. In one example, the wireless network 153 can comprise a Global SIM network that implements LTE Cat1 bis (in other examples, the wireless network 153 can instead (or additionally) communicate with container bolt seal 151 using one or more other technologies/protocols). Further, one or more cloud servers 155 exchange data/information with container bolt seal 151 (via wireless network 153). In addition, the one or more cloud servers 155 exchange data/information with customer backend 157 (which can comprise, for example, an IoT platform and/or website) and with Portal 159 (which can comprise a geospatial mapping application and/or a website). Communications can be bi-directional as desired, for example: (a) the container bolt seal 151 can transmit messages (e.g., bolt-locking message, status messages, bolt-cutting message) up to the one or more cloud servers 155 (through the wireless network 153) and can receive instructions, control data, and the like down from the one or more cloud servers 155 (through the wireless network 153); (b) the customer backend 157 can receive data (e.g., based on the messages transmitted by the container bolt seal 151) down from the one or more cloud servers 155 and can transmit instructions/data up to the one or more cloud servers (e.g., for forwarding to the container bolt seal 151); and/or (c) portal 159 can receive data (e.g., based on the messages transmitted by the container bolt seal 151) down from the one or more cloud servers 155 and can transmit instructions/data up to the one or more cloud servers (e.g., for forwarding to the container bolt seal 151).

Still referring to FIG. 1C, in operation, the container bolt seal 151 can be placed on a shipping container latch as described herein. When the locking member is attached to the shaft portion, one or more sensors in the container bolt seal 151 will detect this bolt-sealing event and transmit a corresponding message (which can include a timestamp (e.g., at a 1 millisecond resolution) and a location (e.g., using latitude/longitude coordinates)). Further, at each of a number of times (e.g., periodically) after the bolt-sealing event, the container bolt seal 151 will transmit a status event (which can include a timestamp (e.g., at a 1 millisecond resolution) and a location (e.g., using latitude/longitude coordinates, mobile country code, mobile network code, base station identifier, and/or local area code)). Further still, when one or more sensors in the container bolt seal 151 detect a cutting of the container bolt seal 151 as a bolt-cutting event, the container bolt seal 151 will transmit a corresponding message (which can include a timestamp (e.g., at a 1 second resolution) and a location (e.g., using latitude/longitude coordinates)). Each of the customer backend 157 and the portal 159 can display information based upon the messages transmitted from the container bolt seal 151. In one example, the customer backend 157 can utilize an API to exchange information and/or control the container bolt seal 151. In one example, the portal 159 can display the location and respective status of the container bolt seal 151 on a map at each of a plurality of points in time. Of course, while one container bolt seal is shown in this example, the system 150 can work with any desired number of container bolt seals (e.g., each of the customer backend 157 and the portal 159 can display time/location/event information for each of a plurality of container bolt seals).

As described herein, various embodiments provide a system to allow one or more interested parties to know when and where a container bolt seal is closed and cut. Benefits of various embodiments include: (a) Minor change to existing process; (b) Useable on any container; (c) Seal form factor and/or characteristics as accepted by various governmental bodies (e.g., customs); and/or (d) Simple to implement via software as a service (SaaS).

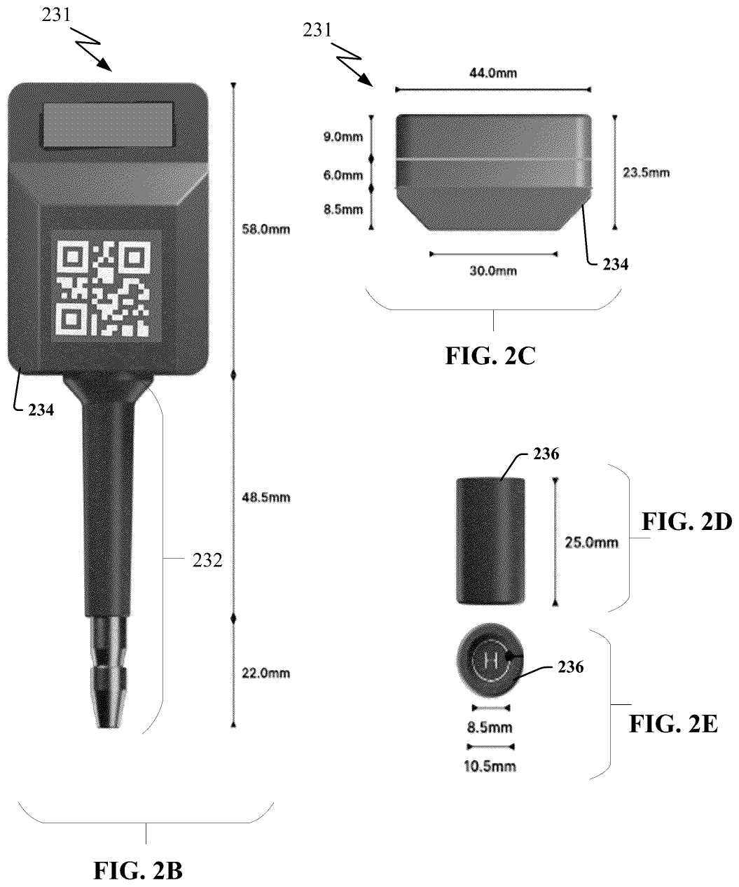

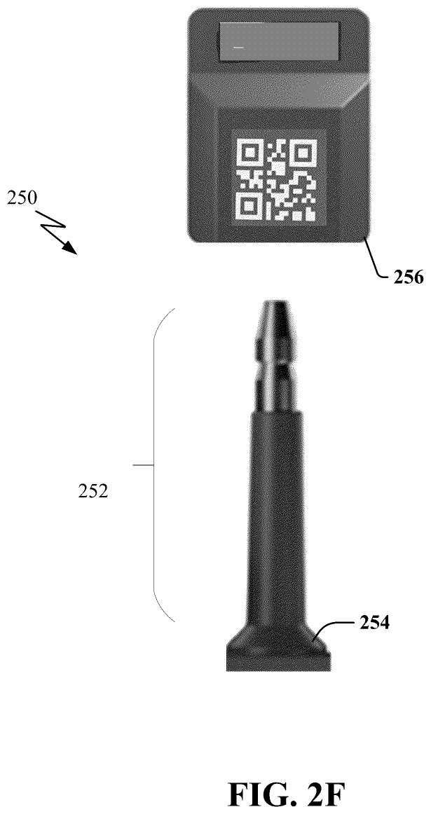

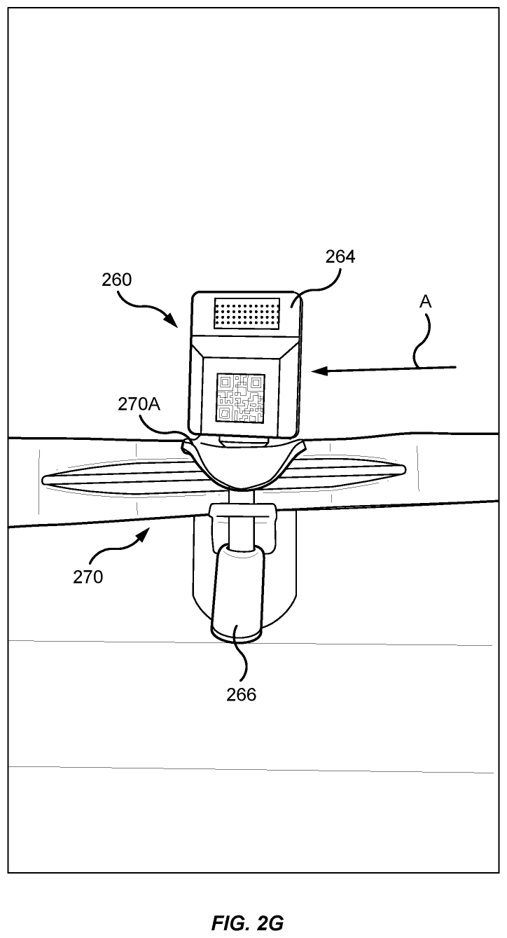

Referring now to FIG. 2A, this is a diagram illustrating a partially cut-away view of an example, non-limiting embodiment of a container bolt seal 200 in accordance with various aspects described herein. As seen in this figure, the container bolt seal 200 comprises a rod portion 204, a head 202 and a locking member (sometimes referred to as a “barrel”) 206. The locking member 206 is configured to be attachable to the rod portion 204 (at an end of the rod portion opposite the head).

Still referring to FIG. 2A, the container bolt seal 200 can include a processor 210 (e.g., a microprocessor), an antenna, an energy storage/distribution element 212 (e.g., a battery), and one or more sensors. The processor can utilize the sensors to detect one or more events as described herein (e.g., a bolt-sealing event when the locking member 206 is attached to the rod portion 204, a bolt-cutting event when the rod portion is cut (or the head 202 is otherwise removed, or the locking member 206 is otherwise removed). Further, the processor can utilize the antenna to transmit one or more messages indicating: the occurrence (time and location) of a bolt-sealing event, the occurrence (time and location) of a status event, and/or the occurrence (time and location) of a bolt-cutting event. Further, the processor can utilize the antenna to receive one or more instructions, commands, updates, or the like. In one example, the processor, the antenna, the energy storage/distribution element, and the one or more sensors (or parts of such sensors) are located in the head 202. In one example, the one or more sensors can comprise a wire or cable that travels from the head 202 to the locking member 206 to form a circuit (see, e.g., the vertical line in the figure that runs from the head to the locking member). In one example, the one or more sensors can comprise a wire or cable that travels in a U-shape from the head 202 down to the locking member 206 and back up to the head 202 to form a circuit.

Referring now to FIGS. 2B and 2C, these are diagrams illustrating a front view (FIG. 2B) and a top view (FIG. 2C) of an example, non-limiting embodiment of a portion of a container bolt seal 231 in accordance with various aspects described herein. This container bolt seal 231 is similar to container bolt seal 101 of FIGS. 1A and 1B (with one difference being that the container bolt seal 231 has a different shaped head 234). The container bolt seal 231 also includes rod 232 (which functions similar to rod 102 of FIGS. 1A and 1B). The shape of head 234 permits use of a larger battery and/or super capacitor (as compared with the head of container bolt seal 101). The dimensions shown in FIGS. 2B and 2C are for example only, and are not restrictive.

Referring now to FIGS. 2D and 2E, these are diagrams illustrating a front view (FIG. 2D) and a top view (FIG. 2E) of an example, non-limiting embodiment of a container bolt seal cap (or locking member) 236 in accordance with various aspects described herein. This container bolt seal cap 236 is similar to container bolt seal locking member 106 of FIGS. 1A and 1B. The dimensions shown in FIGS. 2D and 2E are for example only, and are not restrictive.

Referring now to FIG. 2F, this is a diagram illustrating a front view of an example, non-limiting embodiment of a container bolt seal 250 in accordance with various aspects described herein. As seen in this figure, the container bolt seal 250 comprises a rod portion 252, a formed head 254 and a locking member 256. The locking member 256 is configured to be attachable (e.g., non-removably attachable) to the rod portion 252 (at an end of the rod portion opposite the head). In this embodiment, the locking member 256 includes the electronics, energy distribution mechanism (e.g., battery, capacitor), antenna, and the like for operating as described herein (e.g., to detect close/status/cut and to report thereon).

Referring now to FIG. 2G, this is a diagram illustrating a front view of an example, non-limiting embodiment of a container bolt seal 260 (as installed on an example shipping container) in accordance with various aspects described herein. As seen in this figure, the shipping container has a door handle 270. The door handle 270 interfaces with a retainer lip 270A that is rotatably attached to the shipping container door by a rivet (not shown, but located on the door behind the head 264 as indicated by the horizonal arrow “A”). The container bolt seal 260 is installed such that the container bolt seal is held captive by head 264 and locking member (or “barrel”) 266. Thus, according to various embodiments, by blocking (or restricting) access to the rivet behind the head 264, additional security is provided (for example, the head 264 can function so that the rivet cannot be removed and later on refitted by a bad actor in an attempt to remove the door handle from the door handle retainer without cutting the seal).

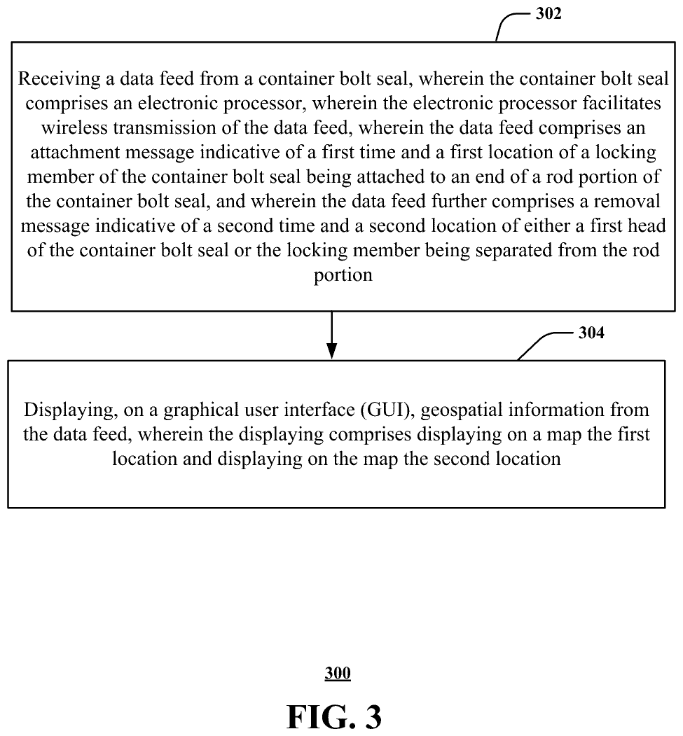

Referring now to FIG. 3, various steps of a method 300 according to an embodiment are shown. As seen in this FIG. 3, step 302 comprises receiving, by a processing system including a processor, a first data feed from a first container bolt seal, wherein the first container bolt seal comprises a first rod portion having a first end and a second end, wherein the first container bolt seal further comprises a first head located at the first end of the first rod portion, wherein the first container bolt seal further comprises a first locking member (sometimes referred to as a “barrel), wherein the first rod portion is sized such that at least a part of the first rod portion can fit through a standard-sized hole in a door locking handle retainer of a shipping container or a standard-sized hole in a “secure cam” position of a shipping container, wherein the first head is sized such that the first head cannot fit through the standard-sized hole in the door locking handle retainer of the shipping container or the standard-sized hole in the “secure cam” position of the shipping container, wherein the first container bolt seal is installed by passing the second end of the first rod portion through the standard-sized hole and then attaching the first locking member to the second end of the first rod portion, wherein the first container bolt seal further comprises a first electronic processor, wherein the first electronic processor facilitates wireless transmission of the first data feed, wherein the first data feed comprises an attachment message indicative of a first time and a first location of the first locking member being attached to the second end of the first rod portion, and wherein the first data feed further comprises a removal message indicative of a second time and a second location of either the first head or the first locking member being separated from the first rod portion. Next, step 304 comprises displaying by the processing system, on a graphical user interface (GUI), geospatial information from the first data feed, wherein the displaying comprises displaying on a map the first location and displaying on the map the second location. In various embodiments, in addition to displaying on a GUI, one or more computer systems (see, e.g., the cloud server(s) 155, the portal 159 and/or the customer backend 157 of FIG. 1C) can also use the location information to compare with a geofence database and the planned journey details for each of the digital bolt seals in order to identify deviation of the planned physical journey route and then based on the outcome of that comparison produce one or more alert messages to the user(s).

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, in various embodiments the digital container bolt seal can comprise (see, e.g., the ISO 17712 standard) a metal rod, threaded or unthreaded, flexible or rigid, with a formed head, secured with a separate locking mechanism. In one example, the rod can have a substantially circular cross section.

As described herein, various embodiments can utilize a process as follows: (a) A user receives a container bolt seal with an Equipment Interchange Receipt, EIR, from a shipping line and then the user records the seal ID (this can be similar to a conventional process); (b) The shipping line or user scans (e.g., with an app) a QR code on the container bolt seal to pair or associate the container bolt seal unique ID with a container ID; (c) The user closes the container doors, locks the doors, and secures the container bolt seal (this can be similar to a conventional process); (d) The container bolt seal detects and reports “seal close” event time and location; (c) On a configurable (e.g., user configurable) interval, the container bolt seal reports status, and time, and location; (f) The container bolt seal is cut to open the doors (this can be similar to a conventional process); (g) The container bolt seal detects and reports “seal cut” event time and location. In one example, a shipping company (and/or other interested party) can filter/find/report an unexpected cut and/or a state in which reporting has stopped.

As described herein, various embodiments can provide a compliant disposable digital bolt seal. The compliant disposable digital bolt seal can be battery operated and/or charged and/or powered by an external power supply and/or an energy harvesting mechanism. The compliant disposable digital bolt seal can be configured for (securely) communicating via mobile, wireless and/or satellite communication technology to provide information about its status, geographical location, sensor values (e.g., temperature, humidity, light, shock, tilt, vibration), log information, hardware (HW) diagnostics, software (SW) diagnostics, performance indicators, date, and/or time. Such information can be transmitted from the compliant disposable digital bolt seal ad hoc and/or on a particular frequency/periodicity (which can be configured as desired). The compliant disposable digital bolt seal can be configured to communicate with a back-end server (e.g., to further enhance the business value of the data). Tracking of the compliant disposable digital bolt seal can be facilitated via use of a Graphical User Interface (GUI) and/or via use of an Application Programming Interface (API) and/or via use of an Electronic Data Interchange (EDI) interface to the container owner's management system. The compliant disposable digital bolt seal can be configured for receiving and storing code updates, configuration information, settings and/or commands. This data/information can be received by the compliant disposable digital bolt seal from one or more external devices via wireless connection(s) and/or wired connection(s). The compliant disposable digital bolt seal can also be configured for receiving and storing information related to a shipping journey (e.g., Shipping Line, Container ID, Journey ID, Origin, Port of Loading. Port of Destination, End destination, Customer). Again, this data/information can be received by the compliant disposable digital bolt seal from one or more external devices via wireless connection(s) and/or wired connection(s).

As described herein, benefits of various embodiments can include: (a) Automated alerting—allows the user and/or container owner to be alerted (e.g., within hours) about when and where the seal was closed and when and where the seal was cut; (b) Based on the alerting, the stake holders can then plan the necessary actions to avoid financial and reputational damage; (c) No (or low) requirement for a specific installation activity—for instance, only a minor change to an existing seal process (pairing the Bolt ID with the Container ID); (d) Versatility—can be used on any container type (e.g., dry, reefer, tank, etc.), powered or not powered; (c) Providing the shipping line visibility on specific routes (e.g., prone to drug trafficking) without having to significantly invest and equip a large part of its fleet with a permanent tracking device; (f) Low cost and Easy to—implement—use of the network and back-end system can be included in the price of the digital bolt seal; (g) Easy to maintain—the digital bolt seal can be a “use once” device that does not require the maintenance of a permanently installed tracking device; (h) Global Coverage—e.g., based on the AT&T global SIM service, the digital bolt seal can communicate in a large number of countries (e.g., over 192 countries); and/or (i) any combination thereof.

In various embodiments, a close detection (e.g., the bolt seal having the locking member attached thereto) can be carried out by one of: (a) a POGO PIN test interface (this can require, for example, a manual activation of the bolt seal with a dedicated connector or tool); (b) a reed-switch; (c) a detecting of a cable short or break to the ground; (d) a detecting of a capacitive change to the bolt seal; (e) a detecting of an inductive change to the bolt seal; (f) a detecting of a resistance change to the bolt seal; (g) a detecting of a conductance change to the bolt seal; (h) any combination thereof.

In various embodiments, a cut detection (e.g., the bolt seal being cut) can be carried out by one of: (a) a cutting of a cable or wire within the bolt seal; (b) a short detected within the bolt seal; (c) a reed-switch change; (d) a capacitance change; (e) an inductance change; (f) a resistance change; (g) a conductance change; (h) any combination thereof.

In various embodiments, when the processor/microprocessor detects such a change associated with cut detection, one or more alarms can be generated and/or reported.

As described herein, various embodiments can provide for a container bolt seal to be securely connected via a wireless network (e.g., a Wide Area Network) to one or more back-end servers.

As described herein, various embodiments can provide for a container bolt seal (e.g., having a Digital Bolt Seal ID) to be paired with a Container ID.

As described herein, various embodiments can provide for a container bolt seal to be tracked via a Graphical User Interface (GUI) and/or via an Application Programming Interface (API).

As described herein, various embodiments can provide an increased business value. Such increased business value can be facilitated via the container bolt seal including Radio Frequency Identification (RFID) capability, Bluetooth Low Energy (BLE) capability, and/or various sensors (e.g., Global Positioning System (GPS) or the like, movement sensor(s), vibration sensor(s), shock sensor(s), temperature sensor(s), humidity sensor(s), light sensor(s)). In addition, such increased business value can be facilitated via configuring the container bolt seal for communications with a back-end reporting and management system.

As described herein, various embodiments can be used in the context of any desired Intermodal Container and/or truck/trailer that can be closed with a container-type door latch.

As described herein, various embodiments can operate on one or more Internet-of-Things (IoT) networks (e.g., spanning many networks across many countries/territories).

As described herein, various embodiments can operate on one or more Long-Term Evolution (LTE) networks, on one or more earlier generation networks, and/or on one or more later generation networks.

As described herein, various embodiments can operate on one or more low-power, wide-area (LPWA) networks.

As described herein, a digital container bolt seal according to various embodiments can communicate via any desired wireless technology/protocol (e.g., mobile wireless, WiMAX, wireless LAN, and/or satellite).

As described herein, a container bolt seal according to various embodiments can be constructed from any desired material(s) such as metal (e.g., steel), Kevlar, etc. In one example, the container bolt seal can be constructed from any desired rigid material(s) that meet certification strength/stress/tension/cut tests.

As described herein, a container bolt seal according to various embodiments can be in a form factor that facilitates use with standard-sized latch mechanisms.

As described herein, a container bolt seal according to various embodiments can be event driven. For example, when a “nut” is put on a “bolt” an electric circuit is formed that will then trigger a message (indicating that the bolt seal is now closed and locked). In another example, the breaking of an electric circuit can be triggered when the bolt seal is cut. In other examples, the detections can be inductive, capacitive, conductive, resistive, or any combination thereof.

As described herein, a container bolt seal according to various embodiments can be tamper proof and/or tamper resistant and/or tamper evident.

As described herein, a container bolt seal according to various embodiments can utilize a hollow shaft portion through which a wire or cable runs to provide detection of sealing and cutting (the wire/cable can, for example, have two terminals and be in a loop or U-shape).

As described herein, a container bolt seal according to various embodiments can detect a cut by a change in a resistance profile of the rod and/or head and/or cap, a change in a conductance profile of the rod and/or head and/or cap, a change in a capacitance profile of the rod and/or head and/or cap, a change in an inductance profile of the rod and/or head and/or cap, or any combination thereof.

As described herein, a container bolt seal according to various embodiments can be powered by a battery, a capacitor, a solar cell, a solar panel, a wireless charging system, and/or an energy harvesting mechanism (e.g., based on mechanical movement, kinetic energy).

As described herein, a container bolt seal according to various embodiments can incorporate one or more embedded sensors such as temperature, humidity, light, shock, tilt, vibration, accelerometer.

As described herein, a container bolt seal according to various embodiments can log: sensor results; and/or processes that are being run by the container bolt seal; and/or processes that have been concluded by the container bolt seal; and/or an indication of success/failure of each process (e.g., if/how many scheduled updates were successful); and/or diagnostic information; and/or performance indicators; and/or time/date. In various examples, reports from the container bolt seal can be generated ad hoc and/or periodically. In various examples, a report can be made when closed and when cut, and/or at a certain frequency (which can be configurable) such as on an hourly basis or every 15 minutes or every day or every week.

As described herein, a container bolt seal according to various embodiments can communicate directly with an end user device and/or with a backend server (which can process and aggregate data from a large number (e.g., hundreds of thousands or million(s)) of container bolt seals). In various examples, the data from the container bolt seals can be processed/manipulated/displayed via a GUI and/or via an API (e.g., stored into a database). In various examples, an end user (or other interested party) can run analysis and exception processing (e.g., so that when they see an event occurring in a location where it was not supposed to, they can start an exception process and/or be alerted and take necessary actions to make sure that the cargo is not being tampered with or there's no bad actors operating).

As described herein, displaying of information (such as digital container bolt seal closed/status/cut/time/location information) and/or the making of such information available to a remote computer via an API can be carried out (according to various embodiments) for a very large number of distinct digital container bolt seals (e.g., on the order of a million digital container bolt seals).

As described herein, intermediate status updates (according to various embodiments) between the sealing event and cutting event can be detected by the digital container bolt seal and/or transmitted by the digital container bolt seal. In various embodiments, these intermediate updates can have a fixed frequency (e.g., every 2 hours), or can be a series of dates and times programmed by means of one or more commands that the digital container bolt seal received. In one example, the digital container bolt seal can receive the command(s) from the cloud server(s) 155 of FIG. 1C. In another example, the dates and times can be configured by user(s) on the portal 159 of FIG. 1C and/or through API command(s) from customer backend 157 of FIG. 1C. This programmed intermediate reporting schedule according to various embodiments can provide certain benefits (e.g., the digital container bolt seal will only consume a significant portion of the battery's energy during times that there is an expected business benefit).

As described herein, a container bolt seal according to various embodiments can be utilized with no (or essentially no) installation activity (e.g., by integrating with an existing shipping process).

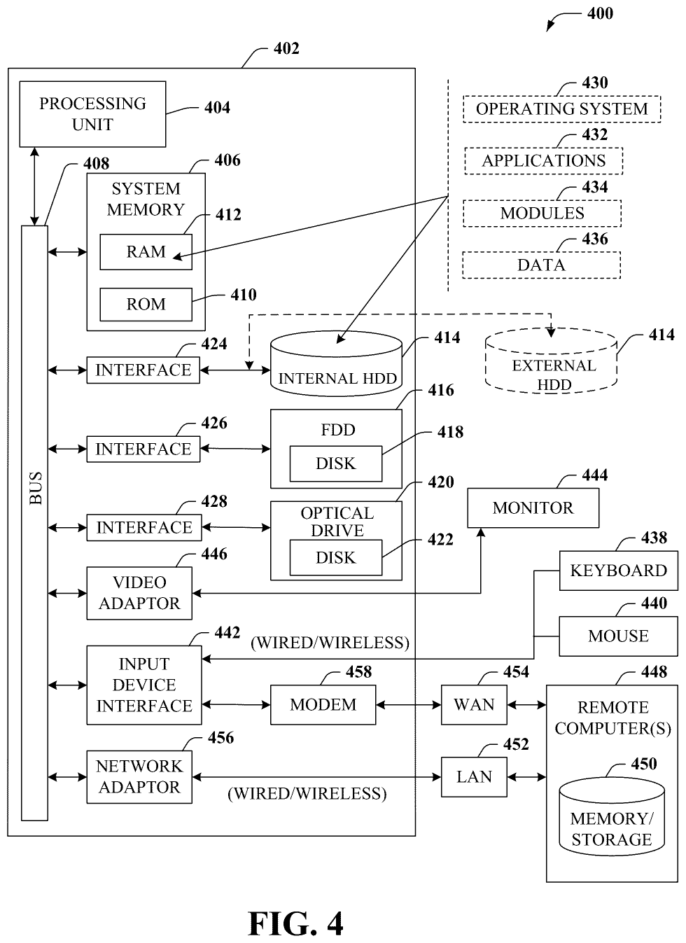

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of a container bolt seal, a wireless network, a cloud server, a customer backend, and/or a mapping portal. Each of these devices can be implemented via computer-executable instructions that can run on one or more computers, and/or in combination with other program modules and/or as a combination of hardware and software. For example, computing environment 400 can facilitate in whole or in part communication with and mapping locations of a container bolt seal.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CDROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402 such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

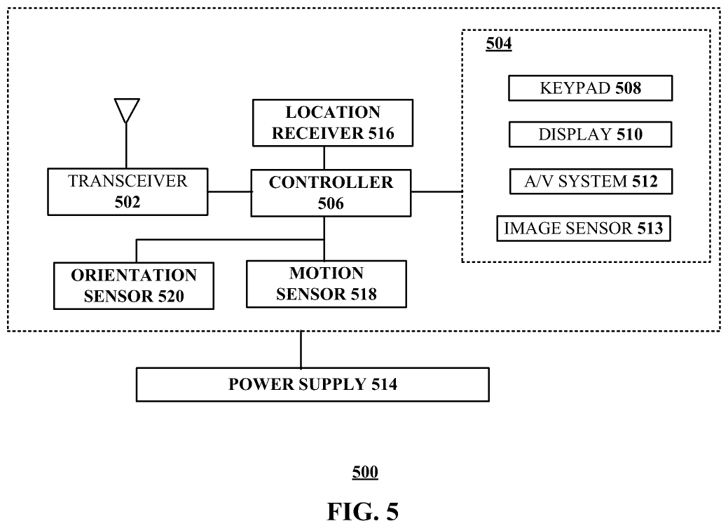

Turning now to FIG. 5, an illustrative embodiment of a communication device 500 is shown. The communication device 500 can serve as an illustrative embodiment of devices such as a container bolt seal, a wireless network, a cloud server, a customer backend, and/or a mapping portal. For example, computing device 500 can facilitate in whole or in part communication with and mapping locations of a container bolt seal. The communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VOIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth®. The keypad 508 can represent a numeric keypad commonly used by phones, and/or a QWERTY keypad with alphanumeric keys. The UI 504 can further include a display 510 such as individual monochrome or multi-color LEDs (Light Emitting Diode), monochrome or color LCD (Liquid Crystal Display), OLED (Organic Light Emitting Diode) or other suitable display technology for conveying information and/or images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface having graphical user interface (GUI) elements that can be selected by a user with a touch of a finger. The display 510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human car) and high-volume audio (such as speakerphone for hands free operation). The audio system 512 can further include a microphone for receiving audible signals of an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable communications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and cast, as well as combined orientations in degrees, minutes, or other suitable orientation metrics).

The communication device 500 can use the transceiver 502 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In other embodiments, the communication device 500 can include a temperature sensor, a humidity sensor, a pressure sensor, and/or a light sensor.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, access history, user preferences, and so forth. This information can be obtained by various methods including user input, detecting types of communications, analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically tracking container bolt seal locations and events) can employ various AI-based schemes for carrying out various embodiments thereof. Moreover, the classifier can be employed to determine a ranking or priority of each container bolt seal, location, and/or event. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the container bolt seals, locations and/or events is to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A container bolt seal, comprising:
a rod portion having a first end and a second end;
a head located at the first end of the rod portion, wherein at least one outer cross-sectional dimension of the head is greater than a largest outer cross-sectional dimension of the rod portion;
a locking member, wherein at least one outer cross-sectional dimension of the locking member is greater than the largest outer cross-sectional dimension of the rod portion, wherein the locking member is configured for placement on the second end of the rod portion, and wherein the locking member becomes non-removably attached to the rod portion after placement on the second end of the rod portion; and
an electronic processor, wherein the electronic processor facilitates wireless communications, wherein the wireless communications comprise a first message indicative of a first time and a first location of a bolt-sealing event and at least one second message indicative of a second time and a second location of a status event, wherein the bolt-sealing event is when the locking member becomes non-removably attached to the rod portion after placement on the second end of the rod portion, and wherein the status event is subsequent to the bolt-sealing event.

2. The container bolt seal of claim 1, further comprising a mechanism to detect the bolt-sealing event.

3. The container bolt seal of claim 2, wherein the mechanism to detect the bolt-sealing event comprises a sensor to detect: a change in resistance, an open circuit, a closed circuit, a change in inductance, a change in capacitance, a change in conductance, or any combination thereof.

4. The container bolt seal of claim 1, wherein the wireless communications further comprise a third message indicative of a third time and a third location of a bolt-cutting event, wherein the bolt-cutting event is when either the head or the locking member are separated from the rod portion, and wherein the bolt-cutting event is subsequent to the bolt-sealing event.

5. The container bolt seal of claim 4, further comprising a mechanism to detect the bolt-cutting event.

6. The container bolt seal of claim 5, wherein the mechanism to detect the bolt-cutting event comprises a sensor to detect: a change in resistance, an open circuit, a closed circuit, a change in inductance, a change in capacitance, a change in conductance, or any combination thereof.

7. The container bolt seal of claim 1, wherein the status event is indicative of a condition in which neither the head nor the locking member are separated from the rod portion.

8. The container bolt seal of claim 1, wherein:
the largest outer cross-sectional dimension of the rod portion is sufficiently small so as to permit the rod portion to pass through a standard-sized lock-receiving aperture in a container door locking handle retainer or secure cam position;
a largest outer cross-sectional dimension of the head is sufficiently large so as to prohibit the head from passing through the standard-sized lock-receiving aperture in the container door locking handle retainer or secure cam position; and
a largest outer cross-sectional dimension of the locking member is sufficiently large so as to prohibit the locking member from passing through the standard-sized lock-receiving aperture in the container door locking handle retainer or secure cam position.

9. The container bolt seal of claim 1, wherein the locking member becoming non-removably attached to the rod portion comprises the locking member becoming unremovable from the rod portion without destructive force being applied to the rod portion, the locking member, or both.

10. The container bolt seal of claim 1, further comprising an energy distribution source that provides energy to the electronic processor, wherein the energy distribution source comprises a battery, a capacitor, a solar cell, a kinetic energy collecting mechanism, or any combination thereof.

11. The container bolt seal of claim 1, further comprising an antenna, wherein the antenna engages in the wireless communications under control of the electronic processor.

12. The container bolt seal of claim 1, wherein the head is formed integrally with the rod portion.

13. The container bolt seal of claim 1, wherein:
the second end of the rod portion comprises a male tapered section; and
the locking member comprises a female receptable for receiving the male tapered section.

14. The container bolt seal of claim 1, wherein:
the wireless communications comprise LTE Cat 1 communications; and
the container bolt seal complies with an International Organization for Standardization (ISO) 17712 standard, a Customs Trade Partnership Against Terrorism (CTPAT) standard, any one or more similar standards, or any combination thereof.

15. An apparatus, comprising:
a rod having an integrated head disposed at a first end of the rod, wherein the rod has a first outside cross-section dimension, and wherein a second outside cross-section dimension of the head is greater than the first outside cross-section dimension of the rod;
a cap element, wherein a third outside cross-section dimension of the cap element is greater than the first outside cross-section dimension of the rod, wherein the rod has a second end opposite to the first end, and wherein the cap element becomes permanently attached to the rod after placement on the second end;
an energy distribution element;
an antenna; and
a processing system configured to be powered by the energy distribution element, wherein the processing system facilitates wireless communications via the antenna, wherein the wireless communications comprise a first message indicative of a first time and a first location of a locking event and a second message indicative of a second time and a second location of a removal event, wherein the locking event is when the cap element becomes permanently attached to the rod after placement on the second end of the rod, wherein the removal event is subsequent to the locking event, and wherein the removal event is when either of the head or the cap element are destructively separated from the rod.

16. The apparatus of claim 15, wherein the energy distribution element, the antenna, and the processing system are disposed in the head.

17. The apparatus of claim 15, wherein the energy distribution element, the antenna, and the processing system are disposed in the cap element.

18. A method, comprising:
receiving, by a processing system including a processor, a first data feed from a first container bolt seal, wherein the first container bolt seal comprises a first rod portion having a first end and a second end, wherein the first container bolt seal further comprises a first head located at the first end of the first rod portion, wherein the first container bolt seal further comprises a first locking member, wherein the first rod portion is sized such that at least a part of the first rod portion can fit through a standard-sized hole in a door locking handle retainer of a shipping container or a standard-sized hole in a secure cam position of a shipping container, wherein the first head is sized such that the first head cannot fit through the standard-sized hole in the door locking handle retainer of the shipping container or the standard-sized hole in the secure cam position of the shipping container, wherein the first container bolt seal is installed by passing the second end of the first rod portion through the standard-sized hole and then attaching the first locking member to the second end of the first rod portion, wherein the first container bolt seal further comprises a first electronic processor, wherein the first electronic processor facilitates wireless transmission of the first data feed, wherein the first data feed comprises an attachment message indicative of a first time and a first location of the first locking member being attached to the second end of the first rod portion, and wherein the first data feed further comprises a removal message indicative of a second time and a second location of either the first head or the first locking member being separated from the first rod portion; and
displaying by the processing system, on a graphical user interface (GUI), geospatial information from the first data feed, wherein the displaying comprises displaying on a map the first location and displaying on the map the second location.

19. The method of claim 18, wherein:
the first data feed further comprises at least one status message indicative of a status time and a status location of a status event that is subsequent to transmission of the attachment message and prior to transmission of the removal message;
the method further comprises receiving, by the processing system, the at least one status message; and
the displaying, on the GUI, further comprises displaying on the map the status location.

20. The method of claim 18, further comprising:
receiving, by the processing system, a second data feed from a second container bolt seal, wherein the second container bolt seal comprises a second rod portion having a third end and a fourth end, wherein the second container bolt seal further comprises a second head located at the third end of the second rod portion, wherein the second container bolt seal further comprises a second locking member, wherein the second rod portion is sized such that at least a part of the second rod portion can fit through another standard-sized hole in another door locking handle retainer of another shipping container or another standard-sized hole in another secure cam position of another shipping container, wherein the second head is sized such that the second head cannot fit through the another standard-sized hole in the another door locking handle retainer of the another shipping container or the another standard-sized hole in the another secure cam position of the another shipping container, wherein the second container bolt seal is installed by passing the fourth end of the second rod portion through the another standard-sized hole and then attaching the second locking member to the fourth end of the second rod portion, wherein the second container bolt seal further comprises a second electronic processor, wherein the second electronic processor facilitates another wireless transmission of the second data feed, wherein the second data feed comprises another attachment message indicative of a third time and a third location of the second locking member being attached to the fourth end of the second rod portion, and wherein the second data feed further comprises another removal message indicative of a fourth time and a fourth location of either the second head or the second locking member being separated from the second rod portion; and
displaying by the processing system, on the GUI, another geospatial information from the second data feed, wherein the displaying the another geospatial information comprises displaying on the map the third location and displaying on the map the fourth location.
